(19) United States
(12) Patent Application Publication
(10) Pub. No.: US 2014/0050986 A1
(43) Pub. Date: Feb. 20, 2014

(54) ACTIVE MATERIALS FOR LEAD ACID BATTERY

(71) Applicants: Subhash DHAR, Bloomfield Hills, MI (US); Fabio ALBANO, Royal Oak, MI (US); Srinivasan VENKATESAN, Bloomfield Hills, MI (US); Erik W. ANDERSON, Royal Oak, MI (US); Susmitha GOPU, Royal Oak, MI (US); Lin HIGLEY, Troy, MI (US)

(72) Inventors: Subhash DHAR, Bloomfield Hills, MI (US); Fabio ALBANO, Royal Oak, MI (US); Srinivasan VENKATESAN, Bloomfield Hills, MI (US); Erik W. ANDERSON, Royal Oak, MI (US); Susmitha GOPU, Royal Oak, MI (US); Lin HIGLEY, Troy, MI (US)

(73) Assignee: Energy Power Systems, LLC, Troy, MI (US)

(21) Appl. No.: 13/768,192

(22) Filed: Feb. 15, 2013

Related U.S. Application Data
(63) Continuation of application No. 13/588,623, filed on Aug. 17, 2012.

(51) Int. Cl. H01M 4/58; H01M 4/21; H01M 4/04; H01M 4/14

(52) U.S. Cl. CPC H01M 4/5825; H01M 4/14; H01M 4/21; H01M 4/0471
USPC 429/225; 428/402; 252/182.1

(57) ABSTRACT

The present disclosure describes a series of improvements to the positive active material and negative active material of electrochemical cells. In particular, the present disclosure describes improvements in the lead oxide powder, processing, and additives used to make the positive active material and negative active material for pastes used to make electrodes for lead acid batteries. The present disclosure describes materials and processing that enable the formation of positive active materials having density comparable to conventional material but with substantially higher porosity and improved mechanical properties and the formation of negative active materials using substantially shorter and less energy intensive processing.

### RELATED APPLICATIONS

This application incorporates by reference the entire disclosure of U.S. application Ser. No. 13/350,505, entitled, “Improved Substrate for Electrode of Electrochemical Cell,” filed Jan. 13, 2012, by Subhash Dhar, et al., the entire disclosure of U.S. application Ser. No. 13/350,686, entitled, “Lead-Acid Battery Design Having Versatile Form Factor,” filed Jan. 13, 2012, by Subhash Dhar, et al., and the entire disclosure of U.S. application Ser. No. 13/475,484, entitled, “Lead Acid Battery with Improved Power Density and Energy Density,” filed May 18, 2012, by Subhash Dhar, et al.

### TECHNICAL FIELD

Embodiments of the present disclosure relate generally to improved materials for making active materials for electrochemical cells, batteries, modules, and battery systems for electric and hybrid-electric vehicles, and more particularly to improved pastes for lead-acid electrochemical cells, batteries, modules, and systems.

### BACKGROUND

Lead-acid electrochemical cells have been commercially successful as power cells for over one hundred years. For example, lead-acid batteries are widely used for starting, lighting, and ignition (SLI) applications in the automotive industry.

As an alternative to lead-acid batteries, nickel-metal hydride (“Ni-MH”) and lithium-ion (“Li-ion”) batteries have been used for electric and hybrid-electric vehicle applications. Despite their higher cost, Ni-MH and Li-ion electro-chemistries have been favored over lead-acid electrochemistry for electric and hybrid-electric vehicle applications due to their higher specific energy and energy density compared to prior known lead-acid batteries.

While lead-acid, Ni-MH, and Li-ion batteries have each experienced commercial success, conventionally, each of these three types of chemistries have been limited to certain applications.

In addition to the differing uses of lead-acid, Ni-MH and Li-ion batteries, the specific energy, energy density, specific power, and power density of these three electro-chemistries vary substantially. Typical values for systems used in hybrid-electric vehicle (HEV)-type applications are provided in Table 1 below.

TABLE 1

| Electro- | Specific | | Volumetric | | Specific | |
|---|---|---|---|---|---|---|
| chemistry | Energy | | Energy | | Power | |
| Type | Density (Wh/kg) | | Density (Wh/l) | | Density (W/kg) | |
| Lead-Acid¹ | 30-50 | Wh/kg | 60-75 | Wh/l | 100-250 | W/kg |
| Nickel Metal | 65-100 | Wh/kg | 150-250 | Wh/l | 250-550 | W/kg |
| Hydride | | | | | | |
| (Ni-MH)² | | | | | | |
| Lithium-Ion | up to 131 | Wh/kg | 250 | Wh/l | up to 2,400 | W/kg |
| (Li-ion)³ | | | | | | |

See, e.g., Reddy, Thomas D., ed., Linden's Handbook of Batteries, at 29-30, McGraw-Hill, New York, New York (4th ed. 2011).

Lead-acid battery technology is low-cost, reliable, and relatively safe. Lead-acid batteries present several advantages over other types of batteries. First, they are a low-cost technology capable of being manufactured anywhere in the world. Accordingly, production of lead-acid batteries readily can be scaled-up. Lead-acid batteries are available in large quantities in a variety of sizes and designs. In addition, they deliver good high-rate performance and moderately good low- and high-temperature performance. Lead-acid batteries are electrically efficient, with a turnaround efficiency of 75 to 80%, provide good “float” service (where the charge is maintained near the full-charge level by trickle-charging), and exhibit good charge retention. Further, although lead is toxic, an extremely high percentage of lead-acid battery components (in excess of 95%) is typically recycled.

Automobile manufacturers have encountered substantial consumer resistance in launching fleets of electric and hybrid-electric vehicles due to the increased cost of these vehicles relative to conventional automobiles powered by an internal combustion engine (“ICE”). Environmental and energy independence concerns have exerted greater pressures on manufacturers to offer cost-effective alternatives to internal combustion engine-powered vehicles. Although electric and hybrid-electric vehicles can meet that demand, they typically rely on subsidies to defray the higher cost of the energy storage systems.

The definitions of various types of electric and hybrid-electric vehicles are not standardized. Among the more significant market segments that are generally recognized are “stop-start” micro-hybrid electric vehicles, mild-hybrid electric vehicles, strong-hybrid electric vehicles, and plug-in hybrid electric vehicles. Table 2 below compares the application of various battery electro-chemistries and the ICE and their current roles in certain automotive applications. As used in Table 2, “Pb-Acid” means lead-acid, “SLI” means starting, lighting, ignition; “HEV” means hybrid-electric vehicle; “PHEV” means plug-in hybrid-electric vehicle; “EREV” means extended range electric vehicle; and “EV” means electric vehicle.

TABLE 2

| | | | Power | | Mild | | | | |
|---|---|---|---|---|---|---|---|---|---|
| | SLI | Start/Stop | Assist | Regeneration | Hybrid | HEV | PHEV | EREV | EV |
| Pb- | ✓ | | | | | | | | |
| Acid | | | | | | | | | |
| Ni- | | | ✓ | ✓ | ✓ | ✓ | | | |
| MH | | | | | | | | | |
| Li- | | | ✓ | ✓ | ✓ | ✓ | ✓ | ✓ | ✓ |
| ion | | | | | | | | | |
| ICE | ✓ | ✓ | ✓ | ✓ | ✓ | ✓ | ✓ | ✓ | |

As shown in Table 2, there remains a need for specific applications in which partial electrification of the vehicle may provide environmental and energy efficiency advantages, without the same level of added cost associated with hybrid and electric vehicles using Ni-MH and Li-ion batteries. Even more specifically, there is a need for a low cost, energy efficient battery in the area of start/stop automotive applications.

In typical lead-acid batteries, the active material is usually formed as a paste that is applied to the battery grid in order to form the plates as a composite material. Although the paste adheres well to itself, it does not adhere well to the grid materials because of paste shrinkage issues. This requires the use of grids that are more substantial and contain additional structural components to help support the active material, which, in turn, puts an extra weight burden on the cell.

Further, during the manufacture of conventional lead-acid batteries, the components are subjected to a number of mechanical stresses. A typical pasting operation involves applying the paste of active material onto the grid, which can stress the latticework of the grid. Expanded metal grids are lighter than cast grids, yet, the formation of the expanded grid itself introduces additional stress at each of the nodes of the expanded grid. These various structural materials, being subjected to substantial mechanical stress during electrode pasting, handling, and cell operation, tend to corrode more readily in the acid-oxidizing environment of the battery after activation, especially when thin plates are used to increase power.

For example, cast and expanded metal grids have non-uniform stress during the life of the battery due to the molar volume change of converting the lead metal to PbO₂. This volume change of the corrosion product puts huge stress on the grids in a non-uniform manner because of the irregular cross-sectional shapes of the grid wires in cast and expanded metals.

Lead-acid batteries have many positive characteristics. The charge-discharge process is essentially highly reversible. The lead-acid system has been extensively studied, the secondary chemical reactions have been identified and their detrimental effects have been mitigated using catalyst materials or engineering approaches. Although its energy density and specific energy are relatively low, the lead-acid battery performs reliably over a wide range of temperatures, with good performance and good cycle life. A primary advantage of lead-acid batteries remains their low-cost.

A conventional lead-acid electrochemical cell uses lead dioxide as an active material in the positive plate and metallic lead as the active material in the negative plate. These active materials are formed in situ. Typically, a charged positive electrode contains PbO₂. The electrolyte is sulfuric acid solution, typically about 1.2 g/cc specific gravity or 37% acid by weight. The basic electrode process in the positive and negative electrodes in a typical cycle involves formation of PbO₂/Pb via a dissolution—precipitation mechanism, causing non-uniform stresses within the positive electrode structure. The first stage in the discharge-charge mechanism is a double-sulfate formation reaction. Sulfuric acid in the electrolyte is consumed by discharge, producing water as the product. Unlike many other electrochemical systems, in lead-acid batteries the electrolyte is itself an active material and can be capacity-limiting.

In conventional lead-acid batteries, the major starting material is highly purified lead. Lead is used for the production of lead oxides for conversion first into paste and ultimately into the lead dioxide positive active material and sponge lead negative active material. Pure lead is generally too soft to be used as a grid material because of processing issues, except in very thick plates or spiral-wound batteries. Lead is typically hardened by the addition of alloying elements. Some of these alloying elements are grain refiners and corrosion inhibitors but others may be detrimental to grid production or battery performance generally. One of the mitigating factors in the corrosion of lead/lead grids is the high hydrogen over-potential for hydrogen evolution on lead. Since most corrosion reactions are accompanied by hydrogen evolution as the cathode reaction, reduced hydrogen evolution will have an inhibiting effect on anodic corrosion as well.

The purpose of the grid is to form the support structure for the active materials and to collect and carry the current generated during discharge from the active material to the cell terminals. Mechanical support can also be provided by non-metallic elements such as polymers, ceramics, and other components. But these components are not electrically conductive. Thus, they add weight without contributing to the specific energy of the cell.

Lead oxide powders that are typically used for the paste typically comprise lead monoxide (PbO) (“litharge”), or Pb₃O₄ (“red lead”). The positive electrode is typically pasted using a combination of litharge and red lead, and the negative electrode is typically pasted using litharge. Commercially available lead oxides for the negative electrode may be prepared by the “Barton Pot” method, resulting in substantially spherical particles having a distribution of particle sizes of about 10 micron in diameter.

Lead oxide is converted into a dough-like material that can be fixed to grids forming the plates. The process by which the paste is integrated into the grid is called pasting. Pasting can be a form of “ribbon” extrusion. The paste is pressed by hand trowel, or by machine, into the grid interstices. Commercially-available pasting machines apply the paste to only one side of the grid. In this configuration, the grid is oriented asymmetrically relative to the active material, resulting in less than optimal utilization of the active material. The present inventors are not aware of any commercial operation producing electrodes for lead acid batteries by pasting both sides of the grid. The amount of paste applied is regulated by the spacing of the hopper above the grid or the type of toweling. As plates are pasted, water is forced out of the paste.

The typical curing process for SLI lead-acid plates is different for the positive and negative plates. Typically, water is driven off the plate in a flash dryer until the amount of water remaining in the plate is between about 8 to 20% by weight. The positive plate may be hydro-set at low temperature (<55 C+/−5C) and high humidity for 24 to 72 hours. The negative plate may be hydro-set at about the same temperature and humidity for 5 to 12 hours. The negative plate may be dried to the lower end of the 8 to 20% range and the positive plate to the upper end of the range. More recently, manufacturers use curing ovens where temperature and humidity are more precisely controlled. In the conventional process steps, the “hydro-set process” causes shrinkage of the “paste” active material that, in turn, causes it to break away from the grid in a non-uniform manner. Shrinkage from conventional processes can be 4%, or more. The grid metal that is exposed is corroded preferentially and, since it is not in contact locally with the active material, results in increased resistance as well as formation and life issues.

A simple cell consists of one positive and one negative plate, with a separator positioned between them. Most practical lead-acid electrochemical cells contain between 3 and 30 plates with separators between them. Leaf separators are typically used, although envelope separators may be used as well. The separator electrically insulates each plate from its nearest counter-electrode but must be porous enough to allow ionic transport in or out of the plates.

A variety of different processes are used to seal battery cases and covers together. Enclosed cells are necessary to minimize safety hazards associated with the acidic electrolyte, potentially explosive gases produced on overcharge, and electric shock. Most SLI batteries are sealed with fusion of the case and cover, although some deep-cycling batteries are heat sealed. A wide variety of glues, clamps, and fasteners are also well-known in the art.

Typically, formation is initiated after the battery has been completely assembled. Formation activates the active materials. Batteries are then tested, packaged, and shipped.

A number of trade-offs must be considered in optimizing lead-acid batteries for various standby power and transportation uses. High-power density typically requires that the internal resistance of the battery be minimal High-power and energy densities also typically require the plates and separators be porous and, typically, that the paste density also be very low. High cycle life, in contrast, typically requires premium separators, high paste density, and the presence of binders, modest depth of discharge, good maintenance, and the presence of alloying elements and thick positive plates. Low-cost, in further contrast, typically requires both minimum fixed and variable costs, high-speed automated processing, and that no premium materials be used for the grid, paste, separator, or other cell and battery components. Some of these goals are antagonistic and may be inconsistent.

A number of improvements have been made in the basic design of lead-acid electrochemical cells. Many of these have involved improvements in the characteristics of the substrate, the active material, as well as the bus bars or collector elements. For example, a variety of fibers or metals have been added to or embedded in the substrate material to help strengthen it. The active material has been strengthened with a variety of materials, including synthetic fibers and other additions. Particularly with respect to lead-acid batteries, these various approaches represent a trade-off between durability, capacity, and specific energy. The addition of various non-conductive strengthening elements helps strengthen the supporting grid but replaces conductive substrate and active material with non-conductive components.

Despite improvements in lead-acid electrochemical cells for automotive applications, prior known lead-acid batteries have not been able to achieve the same performance as Li-ion or Ni-MH cells for similar applications. There remains a need, therefore, for further improvements in the design and composition of lead-acid electrochemical cells to meet the specialized needs of the automotive and stand-by power markets. Specifically, there remains a need for a reliable replacement for lithium-ion electrochemical cells in certain applications that do not entail the same safety concerns raised by Li-ion electrochemical cells. Similarly, there remains a need for a reliable replacement for Ni-MH and Li-ion electrochemical cells with the added benefits of low-cost and reliability of lead-acid electrochemical cells. In addition, there remains a need for substantial improvement in battery production capacity to meet the growing needs of the automotive and stand-by power segments.

The United States Department of Energy (USDOE) has issued Corporate Average Fuel Efficiency (CAFE) guidelines for automotive fleets. Previously, SUVs and light trucks were excluded from the CAFE averages for motor vehicles. More recently, however, integrated guidelines have emerged specifying certain fuel efficiency standards for passenger vehicles, light trucks, and SUVs. These guidelines require an average fuel efficiency of 31.4 miles per gallon by 2016.

Anticipated improvements in internal combustion engine technology do not appear to be able to reach this goal. Similarly, the manufacturing capacity for pure hybrids and pure electric vehicles does not appear to be sufficient to enable fleets to reach this goal. Thus, it is anticipated that some combination of micro-hybrids or mild hybrids, in which electrochemical cells provide some of the power for either stop/start or certain acceleration applications, will be necessary in order to meet the CAFE standards.

Lead-acid battery systems may provide a reliable replacement for Li-ion or Ni-MH batteries in these applications, without the substantial safety concerns associated with Li-ion electro-chemistry and the increased cost associated with both Li-ion and Ni-MH batteries.

Further, the improved batteries of the present invention may be combined in hybrid systems with other types of electrochemical cells to provide electric power that is tailored to the unique automotive application. For example, a lead-acid battery of the present invention which features high-power can be combined with a Lithium-ion (“Li-ion”) or Nickel metal hydride (“Ni-MH”) electrochemical cell offering high energy, to provide a composite battery system tailored to the needs of the particular automotive stand-by or stationary power application, while reducing the relative sizes of each component.

### SUMMARY

The inventors disclose improved components for an active material and an improved active material for an electrochemical cell. The inventors believe that electrochemical cells processed in accordance with the present disclosure have improved properties relative to prior known materials.

The active material of a lead-acid electrochemical cell is preferably PbO₂, following activation. Conventional methods of pasting electrodes for lead acid batteries form other species of lead sulfates that are transformed to PbO₂ during the formation process. These species, however, typically exhibit different structural and crystallographic properties than PbO₂, resulting in mechanical stress, distortion, and changes in volume and phase during the formation process.

The present disclosure describes active materials comprising tetra-basic lead sulfate (TTBLS). TTBLS undergoes isomorphic transformation to PbO₂ during formation, reducing or eliminating many of the problems associated with the transformation of prior known lead sulfate materials upon activation.

As embodied herein, metal oxide powders may be formed by a variety of methods. Lead oxide powders may be formed by a spray drying process. Alternatively, lead oxide powders may be formed by a conventional Barton Pot method. Both tend to form spherical-shaped particles. Alternatively, lead oxide powders may be formed and then ball-milled to a desired size distribution. Commercially available lead oxide powders typically exhibit a distribution of particle sizes centered around a peak value. The peak value of commercially available lead oxide powders is typically between 10 and 15 microns in diameter.

In an embodiment of the present disclosure, the metal oxide powder exhibits a bi-modal distribution of particle sizes. In a preferred embodiment of the present disclosure, as depicted in FIG. 8A a, first particle size distribution exhibits a first peak value at less than or equal to about 15 microns across, and second particle size distribution exhibits a peak value at about less than or equal to 7 microns across. In a more preferred embodiment, as depicted in FIG. 8B, first particle size distribution exhibits a peak value at less than or equal to about 10 microns across, and second particle size distribution exhibits a peak value at less than or equal to about 1 micron across. The powder having a bi-modal distribution of particle sizes exhibits improved “green” (uncured) density in the uncured electrodes and better mechanical properties.

In another embodiment, a metal oxide powder is mixed in a planetary mixer with certain additives to produce a low-shrink paste. The use of a high-speed, high-shear, planetary mixer provides faster mixing times and higher temperatures and shear than conventional mixers.

In another embodiment, active materials permit larger amounts of water to be used in forming the paste, which is beneficial to support TTBLS formation without shrinking or with a reduced amount of shrinkage upon curing. Additionally, the powder forms tetrabasic lead sulfate which enhances the ability to transform isomorphically to PbO and PbO₂.

In yet another embodiment, the paste formed from the powder can be cured effectively at lower temperatures and for shorter time periods, enhancing the manufacturability of electrodes.

In a further embodiment, electrodes formed from the improved active material can be pasted on both sides. In accordance with the present disclosure, when pasted on both sides, the grid is symmetrically disposed within the active material fostering more effective utilization of the volume of the active material.

In other embodiments, TTBLS forms a distinctive crystallographic microstructure having particles with an aspect ratio of from 6:1 to 10:1, or greater. This microstructure provides enhanced mechanical properties to the active material.

Further, the inventors believe that electrochemical cells made from the improved materials of the present disclosure exhibit improved properties, including enhanced cycle life, improved utilization, and increased power.

Additional objects and advantages of the disclosure will be set forth in part in the description which follows, and in part will be apparent from the description, or may be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate certain embodiments of the disclosure and, together with the description, serve to explain the principles of the disclosure.

### BRIEF DESCRIPTION OF THE DRAWINGS

FIG. 1 is an SEM micrograph image of cured positive active material of a preferred embodiment of the present disclosure.

FIG. 2A is an SEM micrograph image of cured positive active material of an alternative preferred embodiment of the present disclosure.

FIG. 2B. is an SEM micrograph of cured positive active material of an alternative preferred embodiment of the present disclosure.

FIG. 3 is a flowchart depicting a process for making a conventional positive active material paste.

FIG. 4 is a flowchart depicting a process for making a positive active material paste of an embodiment of the present disclosure made by thermal and shear stress processing of the present disclosure.

FIG. 5 is a flowchart depicting a process for making a positive active material paste of another embodiment of the present disclosure made by employing additives of the present disclosure.

FIG. 6 is a flowchart depicting a process for making a conventional negative active material paste.

FIG. 7A is a flowchart depicting a process for making a negative active material paste of an embodiment of the present disclosure made by thermal and shear stress processing of the present disclosure.

FIG. 7B is a flowchart depicting a process for making a negative active material paste of another embodiment of the present disclosure made by employing additives of the present disclosure.

FIG. 8A is a graph depicting a bi-modal size distribution of powder particles of an embodiment of the present disclosure.

FIG. 8B is a graph depicting the bi-modal size distribution of powder particles of a preferred embodiment of the present disclosure.

FIG. 9A is a schematic diagram depicting first packing density of relatively uniform-sized particles.

FIG. 9B is a schematic diagram depicting higher packing density of particles having a bi-modal distribution of particle sizes, relative to those depicted in FIG. 9A.

FIGS. 10A and 10B are SEM micrographs of an active material made by conventional processing.

FIGS. 11A and 11B are SEM micrographs of an active material of a preferred embodiment of the present disclosure made by thermal and shear stress processing.

FIG. 12A and 12B are SEM micrographs of a positive active material of a preferred embodiment of the present disclosure made by the addition of micronized TTBLS.

FIG. 13 is an SEM micrograph of a positive active material of an alternative preferred embodiment of the present disclosure made by the addition of micronized TTBLS and micro cellulose fibers and lower temperature processing.

FIG. 14 is an SEM micrograph of a positive active material of an alternative preferred embodiment of the present disclosure made by the addition of micronized TTBLS and micro cellulose fibers and higher temperature processing.

FIG. 15 is an SEM micrograph of a positive active material of an alternative preferred embodiment of the present disclosure made by the addition of higher concentrations of micronized TTBLS and micro cellulose fibers.

FIGS. 16A and 16B are SEM micrographs of a negative active material prepared by conventional processing.

FIG. 17 is an SEM micrograph of a negative active material of a preferred embodiment of the present disclosure prepared in a high shear stress mixture.

FIG. 18 is a Table (Table 3), compiling selected results of the examples of the present disclosure.

### DETAILED DESCRIPTION

Reference will now be made in detail to exemplary embodiments of the present disclosure, examples of which are illustrated in the accompanying drawings. Wherever possible, the same reference numbers will be used throughout the drawings to refer to the same or like parts.

Embodiments of the present disclosure generally relate to improved components of active materials and active material pastes for use in making electrodes of electrochemical cells, improved powders, additives, mixes, and pastes, improved electrodes, and improved electrochemical cells made using these components. Electrodes for lead-acid electrochemical cells typically are in the form of plates. The plates may include multiple components, including, but not limited to, separators, insulators, paste sheets, active material, and a substrate. The substrate may be the portion of the electrode that supports the active material, collects current, and aids in formulating energy and power of a lead-acid electrochemical cell. Embodiments of the present disclosure comprise improved active materials for lead-acid electrochemical cells. Lead-acid electrochemical cells may form lead-acid batteries, which may be used in automobiles for energy storage to aid in increasing fuel efficiency, lead-acid storage batteries for stationary power applications, or any other suitable application.

In some embodiments, a substrate is formed as an expanded metal grid or a wire mesh or in any alternative manner to facilitate current collection and support the active material. In various embodiments, active material in the form of a paste may be applied to the substrate to form an electrochemical plate.

The active material may be selected to enhance performance of the resulting electrochemical cell electrode. The sizes, shapes, and densities of particles of the active material may be chosen to enhance the porosity of the active material and increase the ability of the active material to transport gas out of the material without impairing the flow of electrolyte, which may thereby increase the capacity and catalytic activity of the electrode plates. The present disclosure describes several ways to increase the engineered porosity of the active material.

In certain embodiments, a metal oxide powder is adapted for use in making an active material for electrochemical cells, comprising, first particles having a first size distribution, second particles having a second size distribution, said second size distribution being less than or equal to about one-half of said first size distribution, and said second particles comprising from about 5 to about 25 weight percent of the metal oxide powder. The metal oxide may be a leady oxide and the electrochemical cell may be a lead-acid electrochemical cell.

The leady oxide powder may be formed by any suitable process including, without limitation, thermal or plasma spraying, ball-milling, or grinding. In an embodiment of the present disclosure, the powder has a first size distribution having a peak value about equal to or less than 15 microns across and a second size distribution having a peak value about 7 microns across. In a preferred embodiment, the first size distribution is about less than or equal to about 10 microns and the second size distribution is about less than or equal to 1 micron across. The weight percent of smaller particles may be 10 weight percent, preferably, 15 percent, and more preferably 20 weight percent.

An alternative embodiment comprises a process for making a positive active material paste for use in making an electrochemical cell, comprising the steps of: suspending a metal oxide powder in water; mixing and heating and/or shearing said suspension to form a homogeneous paste; and curing the paste to form an active material. In an embodiment, greater than or equal to 10 weight percent of the paste is tetra-basic lead sulfate. Preferably, the paste is at least 30 weight percent tetra-basic lead sulfate. More preferably, the paste is at least 50 weight percent tetra-basic lead sulfate. And most preferably, the paste is at least 70 weight percent tetra-basic lead sulfate. The suspension may be heated to foster the formation of tetra-basic lead sulfate. The paste may comprise a nucleating agent and may further comprise a shrink-mitigating agent. The uncured paste preferably has a density of between about 3.9 g/cm³ and about 4.4 g/cm³ and a standard globe penetrometer reading of greater than or equal to about 35. The paste preferably has less than or equal to about 4% shrinkage upon curing.

The pastes of the present disclosure may be used to make an active material paste for an electrochemical cell, comprising metal oxide particles having a size distribution about equal to or less than about 15 microns across; a nucleating agent for fostering the formation of terra-basic lead sulfate; water; and sulfuric acid, the paste having a density of between about 3.9 g/cm³ and about 4.4 g/cm³, and the paste having a standard globe penetrometer reading of greater than or equal to about 35. The paste preferably comprises crystals having an aspect ratio of from on or about 5:1 to on or about 10:1.

An electrochemical cell comprising positive active material of the present disclosure may have a microstructure characterized by greater than or equal to 10 weight percent tetra-basic lead sulfate in the cured paste. The positive active material may further comprise microstructures having an aspect ratio greater than or equal to 5:1, plate-like microstructures, or twinned microstructures that may offer increased porosity and increased mechanical stability. In preferred embodiments of the present disclosure, a cell made by the present disclosure may have less than or equal to 20% loss in capacity over the cycle life of the cell. Cycle life of the cell may be greater than or equal to about 1,500 cycles at less than or equal to 80% depth of discharge. An electrochemical cell may further comprise the active material having specific capacity greater than or equal to about 68 mAh/g. Preferably, the active material may have specific capacity greater than or equal to about 70 mAh/g. More preferably, the active material may have specific capacity greater than or equal to about 80 mAh/g. In addition, the electrochemical cell preferably may be fully charged in fewer formation cycles. In a preferred embodiment, it may be charged in one formation cycle at 270% of charge and exhibit flat impedance. Preferably, the electrochemical cell may be fully charged at a voltage of 2.28 volts per cell and exhibit stable C/3 cycling.

Commercially available lead oxide powders typically exhibit a size distribution exhibiting a peak value of less than or equal to about 15 microns in diameter. These particles may form semi-spherical sulfate agglomerates of around 25 μm to 30 μm. Such agglomerates may limit transport of electrolyte.

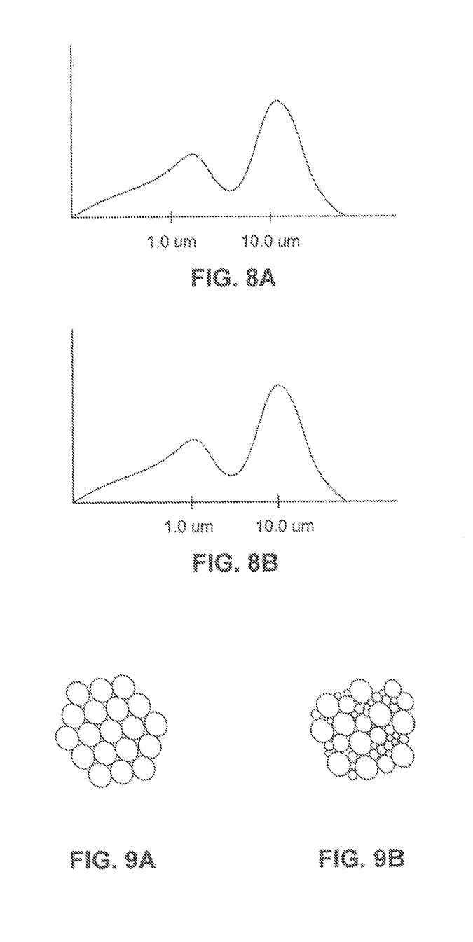

Powder: In a preferred embodiment, the size distribution of particles in the metal oxide powder of the present disclosure may be modified prior to mixing. Specifically, the size distribution of the metal oxide particles may be selected by mixing powders of selected sizes or modified by ball-milling, grinding, or any other appropriate method of modifying particle size. The inventors have found that the time and intensity of milling affects the resulting size distribution. Preferably, a lead oxide powder prepared by the Barton Pot method and having a particle size distribution exhibiting a peak value of about 10 microns in diameter is ball-milled for about 72 hours, resulting in a bimodal distribution of particle sizes. FIGS. 8A and 8B depict a bi-modal size distribution of powders of preferred embodiments of the present disclosure. Milling for a shorter period (for example 48 hours) and/or less intensely may result in less than optimal distribution; similarly, milling for a longer period of time (for example 108 hours) and/or more intensely may modify the size distribution in ways that are not advantageous.

In a preferred embodiment of the present disclosure, as shown in FIG. 8A, the milled powder has a bi-modal size distribution exhibiting a first size distribution about less than or equal to 15 microns and a second size distribution about less than or equal to 7 microns. In a more preferred embodiment, as shown in FIG. 8B, the milled powder exhibits a bi-modal size distribution exhibiting a first size distribution about less than or equal to 10 microns and a second size distribution about less than or equal to 1 micron.

The two peaks may be but need not be equally represented by weight percent or other suitable measure of proportion. In a preferred embodiment of the present disclosure, the weight percent of first, larger particle size distribution may be up to about 75 weight percent and the weight percent of the second, smaller particles size distribution may be up to about 25 weight percent of the powder. In a more preferred embodiment of the present disclosure, the weight percent of first, larger particles may be 83 weight percent and the weight percent of the second, smaller particles may be 17 weight percent. If the weight percent of the smaller particles falls much below about 5 weight percent, the bi-modal distribution of the powder may have a limited impact on the overall density of the resulting powder.

It will be apparent to persons of ordinary skill in the art that particles having first and second size distributions may be generated by a number of alternative methods. For example, particles may be generated by spray drying technologies. This may be done using conventional spray drying equipment, such as that used in the food processing industry but operating at higher temperatures appropriate to the metal oxide particles being formed. Similarly, fluidized bed technologies may be employed. Thus, it is intended that these various methods of forming the particles of varying size distributions be considered part of the present disclosure provide they come within the scope of the present disclosure and appended claims and their equivalents.

In a preferred embodiment of the present disclosure, employing particles of a first and second size distribution may increase the density of the powder. This may be determined by any suitable measuring technique, including, without limitation, BET surface area measurement, tap density, porosity, void fraction, or any other suitable measurement.

Without wishing to be bound by theory, the present inventors believe that employing a metal oxide powder having first and second size distributions enables tighter packing of the metal oxide particles. As depicted schematically in FIGS. 9A and 9B, particles having a bi-modal size distribution may be packed more densely than particles having a substantially uniform size distribution. Increasing density at the same porosity may also enhance the performance of the powder and the mix, paste, and active material formed from it. Thus, the present disclosure may enable packing more active material into the same volume. Higher density may also contribute to longer cycle life.

Additives: In a preferred embodiment of the present disclosure, various additives may be employed. A first additive, micronized tetra-basic lead sulfate (TTBLS) provides nucleation sites for tetrabasic lead sulfate. Micronized TTBLS is commercially available from Hammond Group, Inc., as SureCure®. Boden, et al., U.S. Pat. No. 7,118,830, for Battery Paste Additive and Method for Producing Battery Plates, issued Oct. 10, 2006, which is incorporated herein by reference in its entirety. In a preferred embodiment of the present disclosure, SureCure enhances growth of the desirable crystal forms of TTBLS.

TTBLS can be formed without the use of SureCure or another form of micronized TTBLS but may require higher temperatures. Without wishing to be bound by theory, the present inventors believe that TTBLS can be formed at lower temperatures with the addition of SureCure because the positive active material does not have to overcome the initial nucleation barrier that challenges active material lacking nucleation sites. The present inventors believe that the addition of Sure Cure or another form of micronized TTBLS has a beneficial effect on crystal size and formation.

Micro cellulose fibers may also be added to the active material of a preferred embodiment of the present disclosure. SolkaFloc is a powdered cellulose product of International Fiber Corporation. Again, without wishing to be bound by theory, the present inventors believe that the addition of SolkaFloc or another micro cellulose fiber to the positive active material aids in the formation of TTBLS. SolkaFloc is a fibrous material that helps retain water during mixing, and aids in producing higher mechanical strength and porosity formation in cured electrodes. The higher water content may help convert tri-basic lead sulfate to TTBLS by maintaining sufficient water in close proximity to the growing crystals.

The addition of both SureCure and SolkaFloc, or alternative forms of micronized TTBLS and micro cellulose fibers, to the positive active material in a preferred embodiment of the present disclosure results in larger crystal size than with the addition of SureCure alone. The present inventors believe that the addition of Sure Cure and SolkaFloc have a beneficial effect on crystal size and formation.

Teflon (polytetrafluoroethylene—PTFE) may be added to both the positive active and negative active material as a binder. PTFE is non conductive. It is hydrophobic.

Polyaniline may also be added to the positive active and negative active material as a binder. Polyaniline is an electrically conductive polymer manufactured by Panipol. It too is hydrophobic. It provides conductivity to the mix as well as acting as a binder. Its hydrophobic property controls the amount of flooding of electrolyte in the pores. Binders such as Polyaniline and PTFE support mechanical integrity of electrodes during cycling and may extend the cycle life. During cycling, gases are released. These gases can escape through hydrophobic pathways created by these additives. Moreover they enhance the mechanical stability of the electrode by binding together dissimilar materials.

Carboxy Methyl Cellulose (CMC) may be added to the positive active material as a porosity enhancer. CMC is a cellulosic material. When present in the active material, it is attacked and destroyed by strong acids, such a sulfuric acid, leaving voids in the active material upon formation. In contrast, SolkaFloc, which is also destroyed, leaves channels in the active material.

Sasol may be added to the positive active material as a porosity enhancer. Sasol is essentially cotton fiber. It too is attacked by strong acids, leaving pores in the active material.

Polyester fibers may also be added to the positive active material. Polyester fibers are corroded by strong acids, leaving gas pathways. These pathways provide channels for gas evolved during charging and discharging to escape the body of the active material without building up undue pressure or deforming the active material.

Barium Sulfate (BaSO₄), sometimes named as an expander, may also be added to the negative active material as a nucleating agent.

Sodium Sulfate (NaSO₄) may be added to the positive active material as a pore former. Sodium Sulfate decreases the solubility of lead by “common ion effect” and helps buffer the dissolution of lead.

Phosphate may be added to the positive active material and negative material to enhance cycle life. Phosphate is insoluble and conductive. It forms a stable interface in the active material.

Lignins may be added to the negative active material as a twinning enhancer. Lignins are believed to make sulfate crystals twin, producing a steric effect.

In addition, a variety of carbon species may be added to the negative active material. Carbon black may be added to coat the oxide particles during mixing, producing higher conductivity and forming a conductive film. Carbon may also provide an alternate substrate for hydrogen to be discharged aiding the reduction of PbSO₄ to lead.

On float service the electrodes are not fully charged or discharged. This may generate sulfates which would otherwise lead to battery failure. Carbon causes sulfates to twin, forming smaller sulfate particles that are more soluble. Carbon controls sulfation and helps re-dissolve sulfates. Highly purified capacitive carbons are hydrophilic and act as a sulfate nucleating agent. Graphite, graphene, and carbon nanotubes may also be added, although the cost of graphene and carbon nanotubes may be prohibitive. These additives form strong bonds and are stable in H₂SO₄ at the potential region of the negative electrode.

Mixing: Conventionally, metal oxide pastes for lead-acid batteries have been mixed in conventional industrial mixers, such as Hobart or Bosch mixers of the type used in industrial bakeries for mixing dough. The present inventors have found that these types of conventional mixers are suitable for preparing embodiments of the present invention. In other embodiments, however, an alternative mixer has been shown to offer certain advantages.

In conventional mixing of lead oxide pastes for making pasted electrodes for electrochemical cells, the metal oxide is typically mixed with water and sulfuric acid (H₂SO₄). First, the metal oxide is mixed with water forming a mixture having a coarse dough-like consistency. Sulfuric acid is added periodically. The acid addition forms a green solid in the metal oxide/water mixture, which is broken up and distributed by the mixer. These additions generate heat at the point of addition and tend to form clumps. These clumps must be broken up to maintain the homogeneity of the mixture. For a conventional positive plate, typical amounts of the various components may be about 86.95% weight percent PbO, 13 weight percent water, and 0.05 weight percent H₂SO₄. Mixing would proceed in a standard industrial mixer for about 6 minutes, followed by periodic acid additions of acid over a period of about 15 minutes to produce the paste. The paste would then continue to be mixed and allowed to cool for about 20 minutes resulting in an overall mixing time of about 35 minutes.

The resulting mixture is about 30 weight percent tetrabasic lead and the balance of 70 weight percent tribasic lead. Tetrabasic lead is the preferred species as it undergoes isomorphic transformation into PbO₂ upon activation, resulting in substantially the same crystalline structure and volume, with a slightly lower density and slightly higher porosity.

Alternatively, the inventors have found that the use of a high-speed, high-shear, planetary mixer produces good results and dramatically shortens mixing times. Suitable planetary mixers include those manufactured by Mazerustar, Flacktek, or Eirich. In preferred embodiments of the present disclosure, the metal oxide powder having a bi-modal distribution of particle sizes is mixed with hot (preferably near-boiling) water in a high-speed planetary mixer for about 3 minutes. The resultant mix is a homogeneous mixture of dough-like consistency. The H₂SO₄ may then be added to the planetary mixer and mixing continued for an additional period of about 3 minutes. The resulting mixture is about 100 weight percent tetrabasic lead sulfate.

As detailed in the examples described in the present disclosure, the present inventors have been able to achieve substantially the same structures with different mixing regimes. The use of a high-speed, high-shear-stress, planetary mixer is preferred due to the reduction in mixing time and enhanced homogeneity and lower mixing temperatures.

Paste: In a preferred embodiment of the present invention, the resulting paste suffers little or no shrinkage upon curing. The paste is characterized by needlelike structures, namely particles having an aspect ratio in which the length of the particle is a multiple of its width. These needlelike particle offer improved corrosion resistance. They also provide increased porosity in the active material.

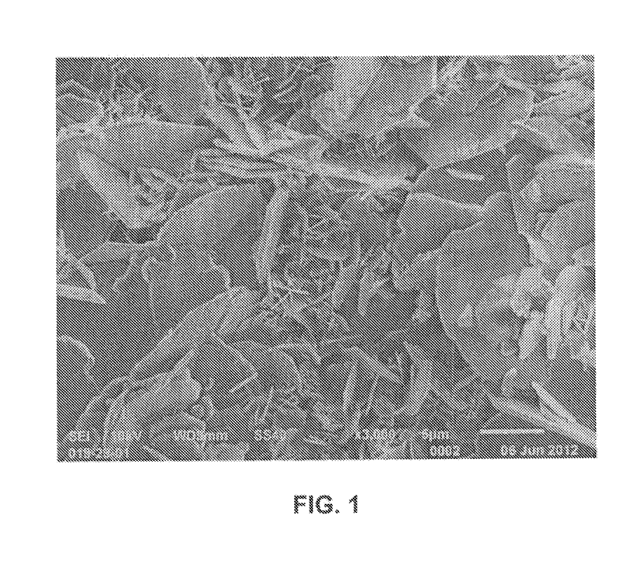

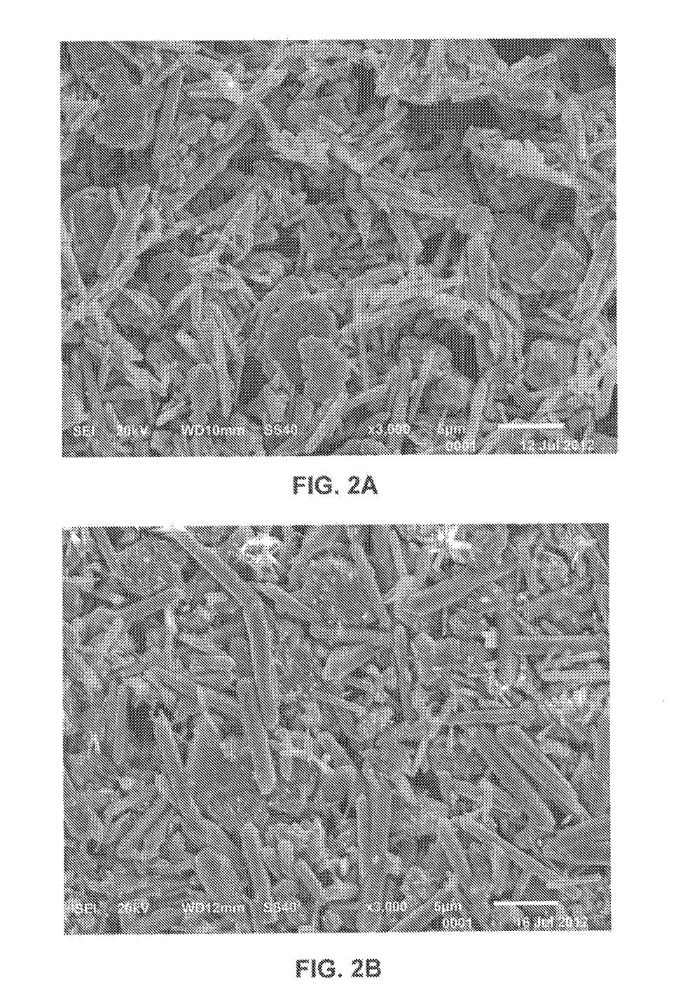

As depicted in FIGS. 2A and 2B, the aspect ratio of the needle-like structures in a preferred embodiment of the present disclosure is preferably 6:1 to 7:1, and more preferably 10:1. The paste of a preferred embodiment is also characterized by having more, smaller particles. As depicted in FIG. 1, the particles in a preferred embodiment may also exhibit twinning, characterized by a strong mechanical bond between adjacent crystals in the twinned pairs. This may contribute to better conductivity and cross-connection. In this configuration the needle-like particles afford high surface area, high degree of mechanical integrity, and uniform porosity throughout the active material. The inventors believe that these characteristics are correlated with higher power, increased capacity, and longer cycle life.

Additionally, the paste of a preferred embodiment of the present disclosure exhibits higher hardness as measured by a standard globe penetrometer test. Battery Council International Technical Manual, Section 2, test procedures for Battery Materials. Whereas conventional cured pastes for electrochemical cells may exhibit a globe penetrometer hardness of 18 to 24, cured pastes of a preferred embodiment of the present disclosure may exhibit globe penetrometer hardness in excess of 35. Various ASTM standards may be used to assess the mechanical properties of the cured paste, including, without limitation, ASTM C1327, ASTM C1326, ASTM C849, and ASTM C1674-11 which establish standard tests for Flexural Strength for Advanced Ceramics With Engineered Porosity.

Curing: In conventional processes for making lead-acid plates for electrochemical cells, higher humidity at the curing step typically leads to longer curing times. In prior known processes for forming electrodes for lead-acid batteries, curing typically results in shrinkage of about 4% of the pasted electrode. In addition to mechanical stress, shrinkage causes cracking of the active material which may distort the active material and leave large portions of the active material isolated, adding weight without any electrochemical benefit to the cell. Embodiments of the present invention suffer less shrinkage. Shrinkage of embodiments of the present disclosure will be about 0.5%.

In contrast to standard pastes which are typically soft even following curing, the pastes of the present disclosure are relatively hard. Cured pastes of embodiments of the present disclosure may be ceramic-like. Whereas, conventional pastes shed after formation, the pastes of the present disclosure resist shedding. The present invention enables formation at lower charge and for fewer cycles. Impedance is lower and electrochemical cells formed using these materials yield higher utilization numbers.

In certain embodiments, the following ingredients are used to make the paste. Alternative embodiments may include variations of amounts, deletion of ingredients, substitution of ingredients, or additional ingredients.

| Ingredient | Wt. Percent |
|---|---|
| PbO | 58.284 |
| Red Lead (Hammond 87% | 17.037 |
| Red Lead) | |
| Teflon suspension(60% Teflon | 0.600 |
| solids, diluted to 1.22 g/cc | |
| specific gravity) | |
| Na₂SO4•10H₂O | 0.675 |
| H₂SO₄ (1.4 specific gravity) | 3.676 |
| Deionized Water | 17.085 |
| Micronized Tetrabasic Lead | 0.753 |
| Sulfate (SureCure) | |
| Cellulosic floc (SolkaFloc) | 1.889 |
| | 100.000 |

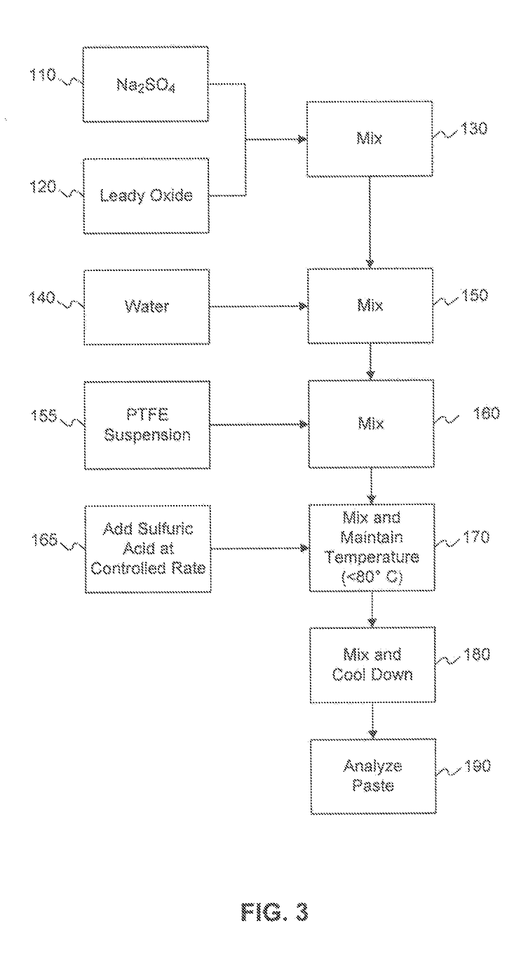

Positive Active Material Paste (Conventional Processing): FIG. 3 is a flowchart depicting a conventional process for making a positive active material paste. In a conventional process, Na₂SO₄ and a leady oxide powder 120 are added to mixer 130. The leady oxide powder 120 is typically a mixture of commercially available lead oxide (litharge or Massicot) and red lead. Conventionally, the Na₂SO₄ 110, leady oxide powder 120, and water 140 are mixed 150 in a commercial mixer, for about 3 to 5 minutes at ambient temperature. A PTFE suspension 155 is then added to the mixer and mixing continues 160.

Sulfuric acid 165 is added to the mixer at a controlled rate while mixing 170 continues for an additional 10 to 15 minutes. A metering pump drips the sulfuric acid into the mixer. The sulfuric acid 165 reacts with the leady oxides 120 to produce lead sulfate and heat. The reacted regions of lead sulfate are broken up by the mixer and distributed throughout the mixture homogeneously as leady sulfate particles. The temperature of the mixture is typically below 80° C., in conventional processing 170. This fosters the formation primarily of tri-basic lead sulfate. Depending on the batch size, supplemental cooling or heating may be required to maintain the temperatures in this range 170. Mixing is continued for an additional 15 minutes as the mixture is allowed to cool 180.

The mixture is then analyzed 190 to ensure that the paste quality is acceptable. Typical measurements include density, consistency, phase composition, chemical composition and homogeneity. In conventional processing, the density of the finished paste is preferably 3.90 to 4.40 g/cm³. Standard globe penetrometer test readings of 20-35 are typical in conventional processing.

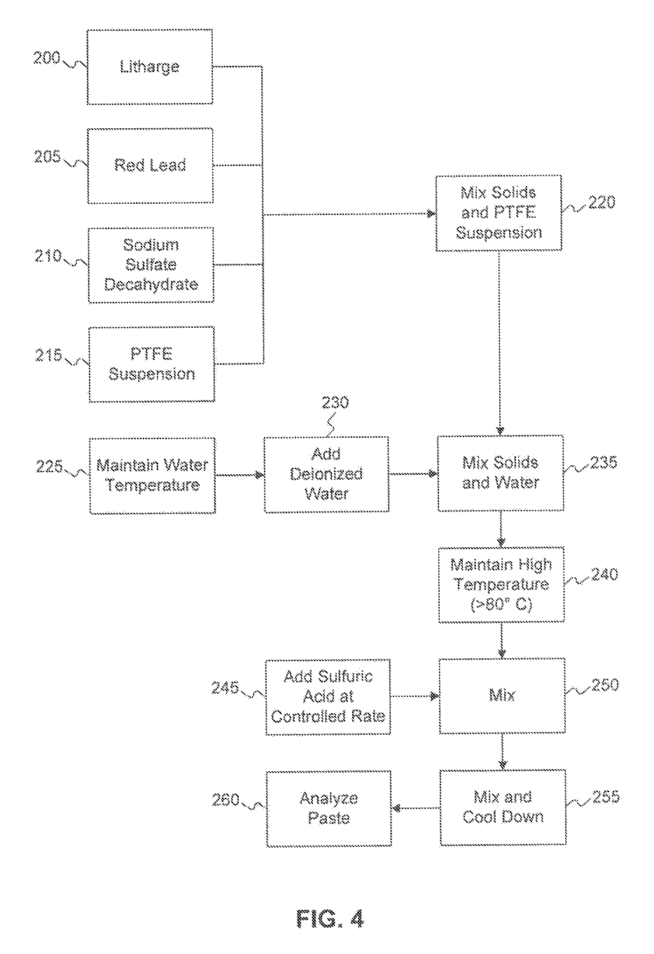

Positive Electrode (Thermal and Shear Processing): FIG. 4 depicts a process for making a positive active material paste of an embodiment of the present disclosure using thermal and shear stress processing. The mixer of a preferred embodiment of the present disclosure is not a conventional mixer 130 but rather a high-speed, high-shear stress, planetary mixer 220. High-speed, high-shear stress, planetary mixers of this type are made by SpeedMixer (manufactured by Flacktek), Brabender, and Mazerustar. Mixers of this type typically generate forces of over 700 g and spin at speeds from 1,800 to 3,000 rpm.

The solids 200, 205, 210, and 215, are first added to the mixer. Leady oxides, preferably litharge 200 and red lead 205 (for example, Hammond 87% red lead), are added to the mixer 220 with Sodium Sulfate Decahydrate 210 and a solution of PTFE (polytertafluoroethylene) having 60% solids and 1.2 g/cc specific gravity 215. The solids and PTFE suspension are then mixed 220 for about 3 minutes.

Typically, planetary mixers employ batch processing. The mixer is stopped and hot deionized water 225 is added 230 to the mixture 235 and mixing is resumed for 2-4 minutes 235. Depending on processing conditions, the mixer may generate sufficient shear stress to raise the temperature of the mixture by friction. Supplemental heating may be provided, if needed. In a preferred embodiment, the mixture is maintained at a temperature of over 80° C. 240 to foster the formation of tetra-basic lead sulfate. A further advantage of using a high-speed, high-shear stress, planetary mixer is that it provides a closed, isolated environment which prevents loss of water from the mixture.

Sulfuric acid 245 is then added to the mixture in incremental steps over a period of approximately 8 minutes. Mixing continues between sulfuric acid additions 250. The temperature is monitored to ensure that the temperature of the mixture remains favorable for the formation of tetra-basic lead sulfate 250. After the last sulfuric acid addition, mixing is continued for an additional 5 minutes 255 to allow crystal growth and to allow the mixture to cool down. In contrast to conventional processing, which produces primarily tri-basic lead sulfate paste, the processing of a preferred embodiment fosters the formation primarily of tetra-basic lead sulfate paste.

The mixture is then analyzed 260 to ensure that the paste quality is acceptable. If the paste is too thick, additional water may be added to the mixture and mixing continued. In a preferred embodiment of the present disclosure using thermal and shear stress processing, the density is approximately the same as for a conventional positive active material. The viscosity of the positive active material of embodiments of the present disclosure, however, is much lower. This is due to the enhanced porosity of the paste. Standard globe penetrometer measurements of a paste formed by conventional processing range from 10 to 35. Standard globe penetrometer measurements of an embodiment made by the thermal and shear stress processing of a preferred embodiment of the present disclosure would exceed the range of the standard globe penetrometer measurement device. A modified penetrometer was made with ¼ of the standard weight. Modified penetrometer readings of a positive active material of preferred embodiments (both thermal and additives) were in the range of 25-35, which would correspond to a reading of 80-90 on a standard globe penetrometer.

Conventional knowledge would indicate that a paste having this level of viscosity would be unusable as an active material due to excessive shrinkage from water loss. Contrary to these teachings, the present inventors have found that this is not the case and that embodiments of the present disclosure made using the thermal and shear stress processing of the present disclosure produce suitable pastes for use as an active material.

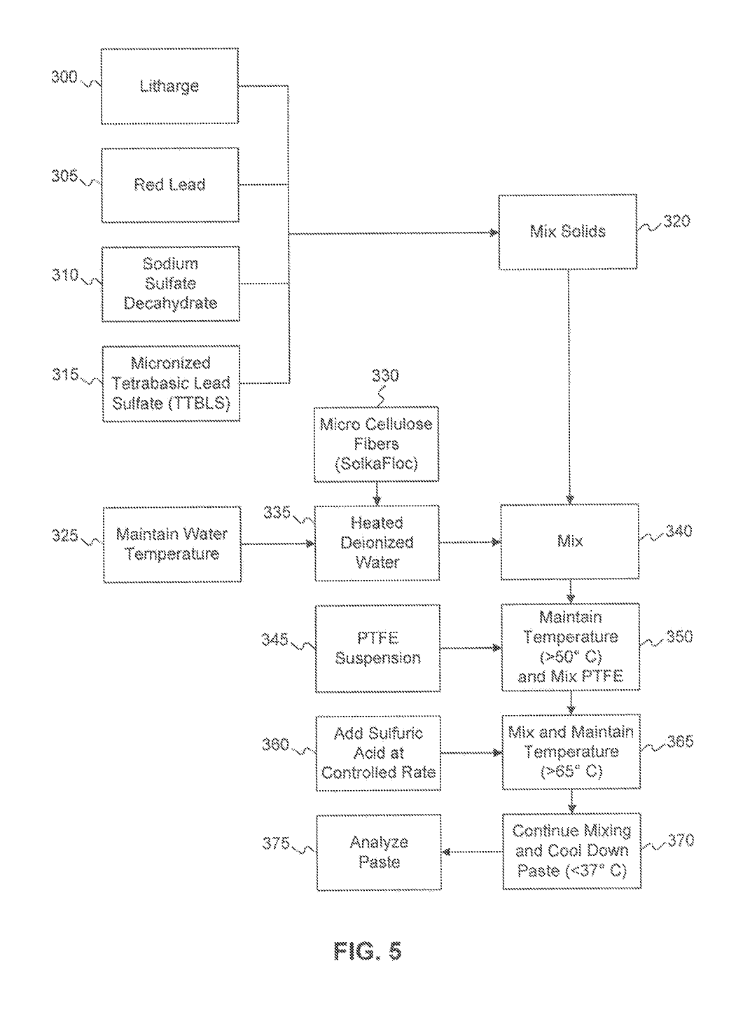

Positive Active Material (Additives): FIG. 5 depicts a process for making a positive active material paste of a preferred embodiment of the present disclosure using additives. The mixer 320 of this preferred embodiment may be either a conventional mixer 130 or a high speed, high shear stress, planetary mixer 220. If a conventional mixer 130 is used, mixing times are consistent with those described above for conventional processing; if a high-speed, high-shear stress, planetary mixer 220 is used, mixing times are consistent with those described above for a preferred embodiment made using the thermal and shear stress processing of the present disclosure.

Solids 300, 305, 310, and 315 are first added to the mixer 320. Leady Oxides, preferably litharge 300 and red lead 305 (for example, Hammond 87% red lead) are added to mixer 320 with Sodium Sulfate Decahydrate 310 and micronized tetra-basic lead sulfate 315 (Hammond SureCure®). The solids are mixed as described above 320.

Micro cellulose fibers (International Fiber Corporation SolkaFloc®) 330 is mixed with heated deionized water 325 and added 335 to the mixture and mixing is continued 340. The temperature of the mixture is maintained above 50° C. to facilitate the addition of the PTFE suspension 350. Supplemental heating may be provided, if needed 350, In a preferred embodiment, a solution of PTFE (poly tetrafluoroethylene) having 60% solids and 1.2 g/cc specific gravity 345 is added while the temperature of the mixture is maintained above 50° C. 350. The elevated temperature facilitates the softening and mixing of the PTFE solution.

Sulfuric acid 360 is then added to the mixture at a controlled rate. Mixing is continued 365 and the temperature of the mixture is maintained above 65° C. Following the sulfuric acid additions, mixing continues 370 and the paste is allowed to cool down to below about 37° C.

In contrast to conventional processing which produces primarily tri-basic lead sulfate paste, the processing of this preferred embodiment fosters the formation primarily of tetra-basic lead sulfate paste through the use of additives, even without the more aggressive thermal and high shear stress processing of alternative embodiments.

The mixture is then analyzed 375 to ensure that the paste quality is acceptable. In a preferred embodiment of the present disclosure, the positive active material made using additives exhibits density and penetrometer measurements comparable to that made using thermal and shear stress processing.

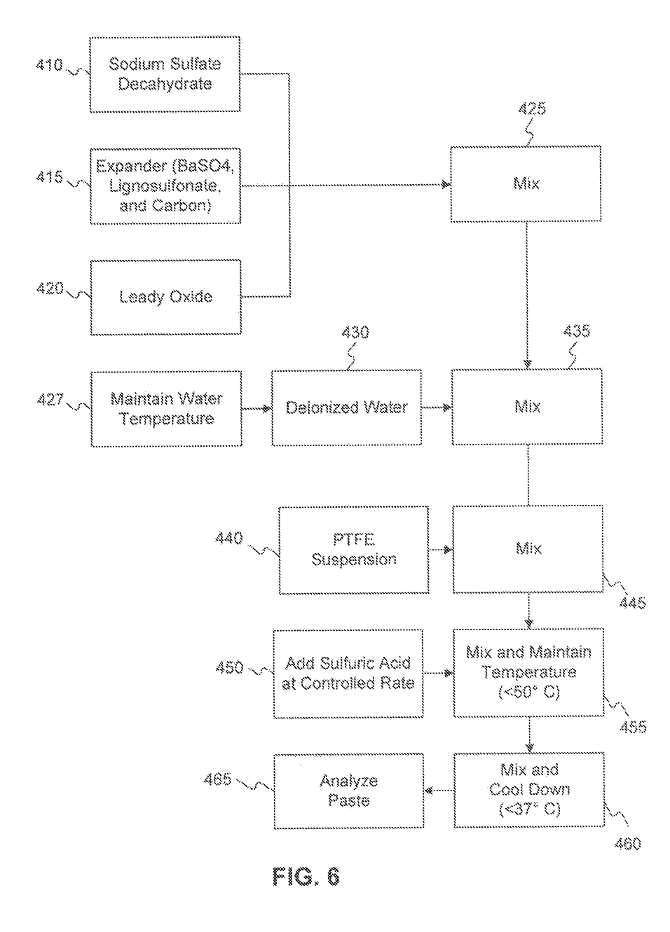

Negative Electrode (Conventional Processing): Processing of the negative electrode paste differs from that of the positive. FIG. 6 is a flowchart depicting a conventional process for making a negative active material paste. In the conventional process, Sodium Sulfate Decahydrate 410, an expander 415, and leady oxide 420, are added to conventional mixer 425. Expander 415 (Hammond HE-C-6 MaxLife®) is a conventional mixture of BaSO₄, lignosulfonate, and carbon (typically carbon black). The leady oxide 420 for the negative active material is typically a mixture of commercially available lead oxides, made by the Barton Pot process. The Sodium Sulfate Decahydrate 410, expander 415, and leady oxide 420 are mixed 425 for 2-4 minutes.

The temperature of deionized water 427 is maintained and deionized water 430 is added to mixer 435. The mixture is then mixed for about 10 to 15 minutes 435. Supplemental heating may be provided, if needed 435. A suspension of PTFE (poly tetrafluoroethylene having 60% solids and 1.2 g/cc specific gravity) 440 is added and mixing continues. 445.

Sulfuric acid 450 is then added to the mixer 455 at a controlled rate while mixing continues 455 for an additional 6 to 10 minutes. Typically, a metering pump drips sulfuric acid 450 into mixer 455. The sulfuric acid reacts with the leady oxides to produce lead sulfate and heat. The reacted regions of lead sulfate are broken up by the mixer and distributed throughout the mixture homogeneously as lead sulfate particles. The temperature of the mixture is typically maintained below 50° C. in conventional processing 455. This fosters the formation primarily of tri-basic lead sulfate paste. Depending on the batch size, supplemental cooling or heating may be required to maintain the temperatures in this range.

Mixing is continued for an additional 10 minutes as the mixture is allowed to cool 460. The mixture is then analyzed 465 to ensure that the paste quality is acceptable. Typical measurements include density, consistency, phase composition, chemical composition and homogeneity.

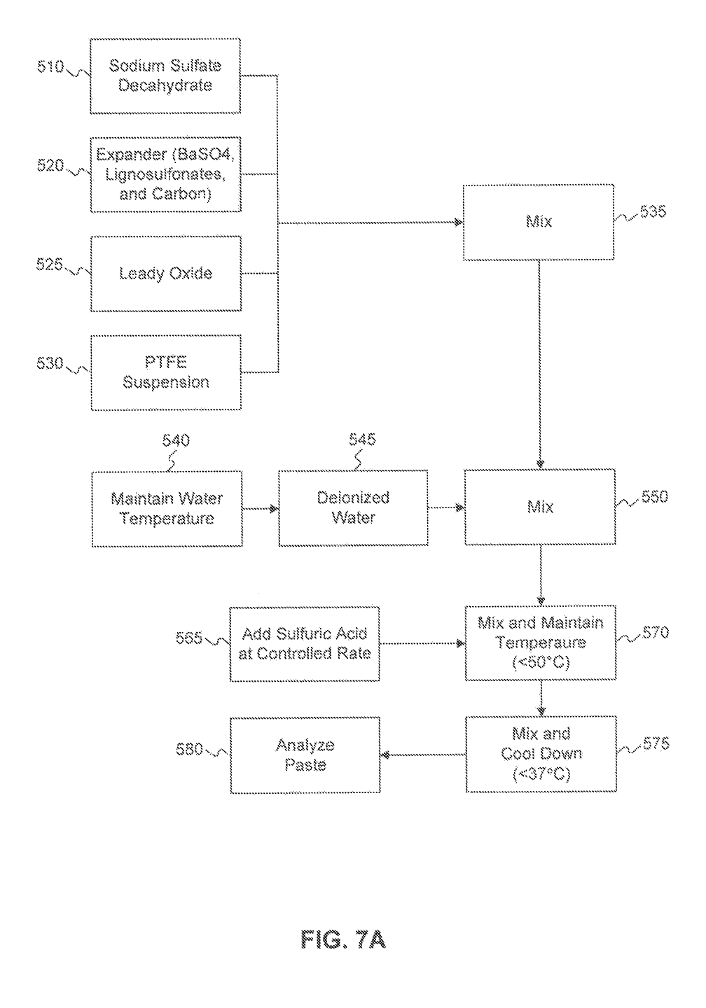

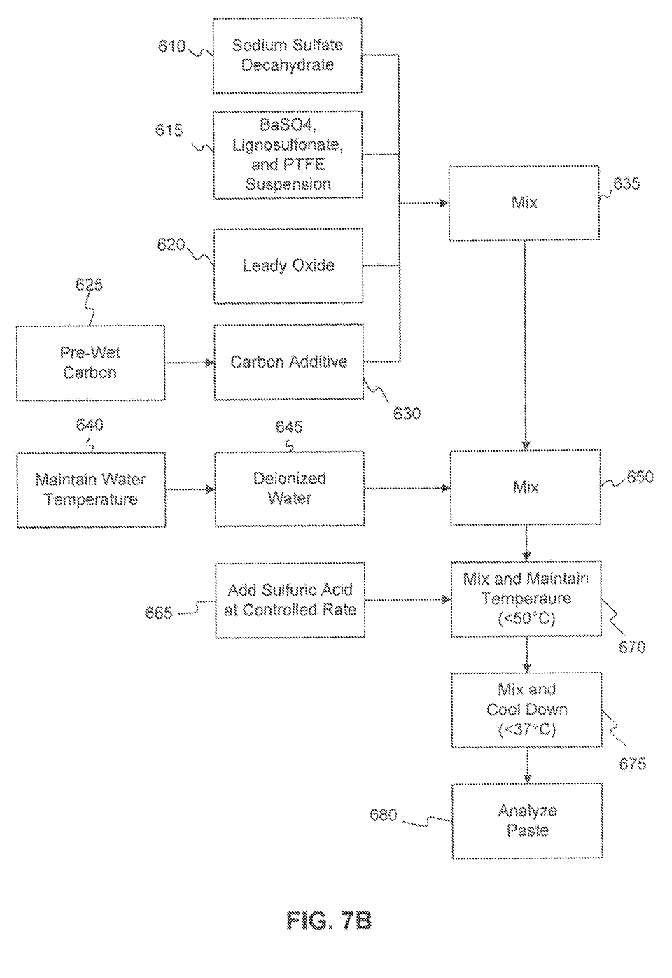

Negative Active Material (Thermal and Shear Processing): FIG. 7A depicts a process for making a negative active material paste of an embodiment of the present disclosure using thermal and shear stress processing. The mixer of this preferred embodiment may be either a conventional mixer 130 or a high-speed, high-shear stress, planetary mixer 220. If a conventional mixer is used, mixing times are consistent with those described above for conventional processing of the positive active material; if a high speed, high shear stress, planetary mixer is used, mixing times are consistent with those for a preferred embodiment of the positive active material using thermal and shear stress processing.

In a preferred embodiment, Sodium Sulfate Decahydrate 510, an expander 520, leady oxides 525, and PTFE suspension 530 are added to mixer 535. Expander 520 (Hammond HE-C-6 MaxLife®) in a preferred embodiment is a mixture of BaSO₄, lignosulfonates, and carbon. In a preferred embodiment, PTFE suspension is a suspension of PTFE (poly tetrafluoroethylene) having 60% solids and 1.22 g/cc specific gravity.

Leady Oxides 525 of a preferred embodiment of the negative active material are preferably litharge or roasted/calcined lead oxide (Hammond 100Y Litharge) having a low level of free-lead. Alternatively, any commercial grade of ball-mill lead oxide may be used. The Sodium Sulfate Decahydrate 510, expander 520, leady oxides 525, and PTFE suspension 530 are mixed for 2-4 minutes 535.

Heated deionized water 540 is then added 545 to mixture 550 and mixing is resumed for 3-5 minutes in a conventional mixer 550.

Sulfuric acid 565 is then added to the mixture at a controlled rate. Mixing is continued for 12 to 15 minutes and the temperature of the mixture is maintained below 50° C. 570. Following the sulfuric acid additions, mixing continues for another 10 to 15 minutes 575 and the paste is allowed to cool down to below about 37° C. In a preferred embodiment, the mixed paste comprises primarily tri-basic lead sulfate paste for the negative active material.

In contrast to conventional processing, a preferred embodiment of the present disclosure produces a negative active material having higher porosity than conventional processing.

Negative Active Material (Additives): FIG. 7B depicts a process for making a negative active material paste of an embodiment of the present disclosure using additives. The mixer of this preferred embodiment may be either a conventional mixer 130 or a high-speed, high-shear stress, planetary mixer 220. If a conventional mixer is used, mixing times are consistent with those described above for conventional processing of the positive active material; if a high-speed, high-shear stress, planetary mixer is used, mixing times are comparable to that of a preferred embodiment of the positive active material using thermal and shear stress processing.

In a preferred embodiment, Sodium Sulfate Decahydrate 610, expander 615, leady oxides 620, and carbon additives 630 are added to mixer 635. The expander (Hammond HE-C-6 MaxLife®) in a preferred embodiment is a mixture of BaSO₄ and lignosulfonates. A suspension of PTFE(polytetrafluoroethylene) having 60% solids and 1.22 g/cc specific gravity) is added along with BaSO₄ and lignosulfate 615. In contrast to conventional carbon, carbon additive 630 has exceptionally high surface area. Conventional carbons are from 300-500 m²per gram, measured by BET surface area; carbons of a preferred embodiment are 900-1500 m²/g, measured by BET surface area. Carbon additive 630 is first wetted 625 so that it will absorb water in advance and mix properly with the remaining components of the mixture 635. The water with which the carbon is pre-treated is deionized water 625.

Leady Oxides 620 of a preferred embodiment of the negative active material are preferably litharge or roasted/calcined lead oxide (Hammond 100Y Litharge) having a low level of free-lead. Alternatively, any commercial grade of ball-mill lead oxide may be used. Sodium Sulfate Decahydrate 610, BaSO₄, lignosulfate, and PTFE suspension 615, leady oxides 620, and pre-wetted 625 carbon additive 630 are mixed for 2-4 minutes 635 at ambient temperature.

Heated deionized water 640 is then added 645 to the mixture 650 and mixing is resumed for 3-5 minutes in a conventional mixer 650. The temperature of the mixture is maintained about 40° C. Supplemental heating may be provided 650, if needed.

Sulfuric acid 655 is then added to the mixture at a controlled rate. Mixing is continued for 12 to 15 minutes and the temperature of the mixture is maintained below 50° C. 660. Following the sulfuric acid additions, mixing continues for another 10 to 15 minutes 670 and the paste is allowed to cool down to below about 37° C. In a preferred embodiment, the paste comprises primarily tri-basic lead sulfate paste for the negative active material.

In contrast to conventional processing, a preferred embodiment of the present disclosure produces a negative active material having higher porosity than conventional processing.

### EXAMPLE 1

A conventional positive active material paste was prepared from lead oxide powder using conventional processing as depicted in FIG. 3. Neither the micronized TTBLS nor micro cellulose additives of preferred embodiments of the present disclosure were used, and the thermal and shear stress processing of the present disclosure also was not used. The samples were prepared in a conventional Bosch mixer.

Sodium sulfate, Na₂SO₄ (about 0.6 to 0.7 weight percent) and 82 weight percent leady oxide (about 64 weight percent PbO and about 18 weight percent Pb₂O₃), were added to the mixer and mixed for 2 minutes. De-ionized water (about 13 weight percent) was heated to about 65° C. and added to the mixer promptly and incrementally over a time period of less than 60 secs. Mixing continued for another 2 to 3 minutes. Teflon suspension having 60% solids and 1.22 g/cc specific gravity (about 0.4 weight percent) was then added to the mix and mixing continued for 6 to 7 minutes. Sulfuric acid having 1.4 g/cc specific gravity (about 4 weight percent) was then added to the mixer at a controlled rate, over a period of 4 minutes and mixing continued between additions. The temperature of the mix was recorded every minute during this time to record the peak temperature. A peak temperature of about 51.6° C. to 60° C. was achieved after the last addition of sulfuric acid. Mixing continued until the mix cooled below about 37° C. The mixture was then analyzed for density and penetrometer measurement.

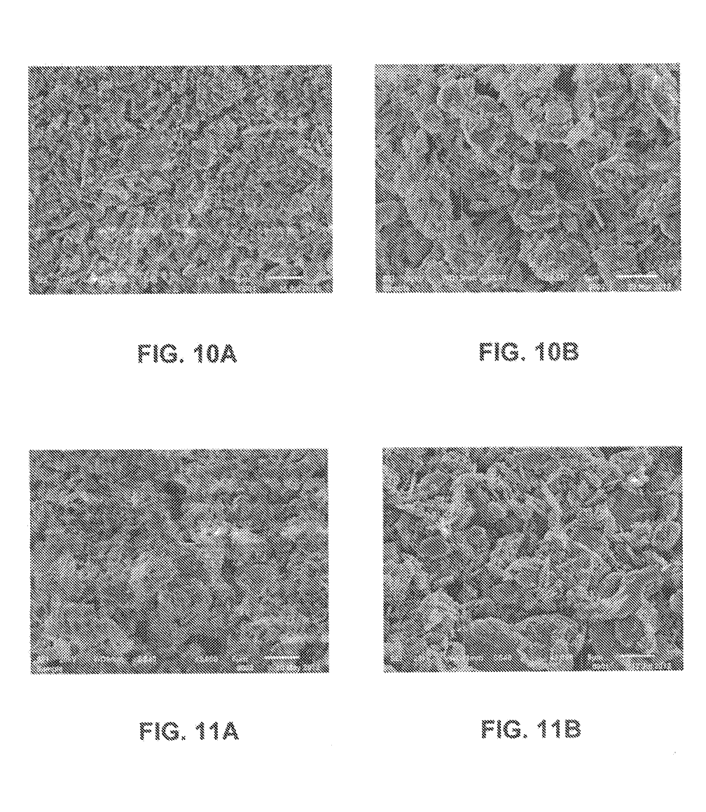

FIG. 10A and 10B are SEM micrograph images of positive active material that was prepared by conventional processing. The active material is primarily tri-basic lead sulfate. The microstructure features substantially spherical agglomerations of lead sulfates and a small percentage of TTBLS is present in the sample.

### EXAMPLE 2

Samples were prepared using the thermal and shear stress processing of a preferred embodiment of the present invention as depicted in FIG. 4. Neither the micronized TTBLS nor micro cellulose additives of preferred embodiments of the present disclosure were used. The samples were prepared in a high-speed, high-shear stress, planetary mixer at elevated temperature and with aggressive mixing to facilitate the formation of TTBLS.

Sodium sulfate Na₂SO₄ (0.65 weight percent), leady oxide (about 62 weight percent PbO and about 18.2 weight percent Pb₃O₄), and a Teflon suspension having 60% solids and 1.22 g/cc specific gravity (0.57 weight percent) were mixed for 1 minute. Deionized water (14.4 weight percent) was pre-heated to about 85° C. and added to the mixer and mixing continued for another 2 minutes. The mixture was then re-heated to above 75° C. Sulfuric acid having 1.4 g/cc specific gravity (about 4 weight percent) was added to the mixer at a controlled rate and mixing continues between additions, over a period of about 4 minutes. The mixture was intermediately re-heated to above 75° C. after each mixing step and before adding more sulfuric acid, if the temperature dropped below 75° C. Mixing continued for an additional 2 minutes while the remaining sulfuric acid reacted and the mixture was allowed to cool.

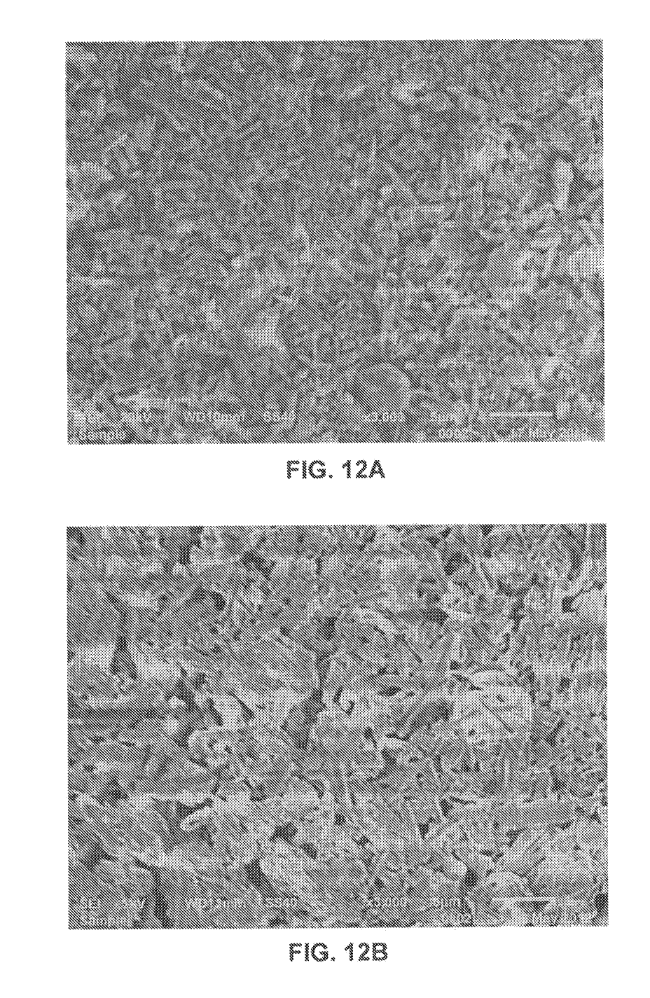

FIG. 11A is an SEM micrograph image of positive active material that was prepared by thermal and shear stress processing of a preferred embodiment of the present disclosure and dry cured at 43° C. for 45 minutes. FIG. 11B is an SEM micrograph image of positive active material that was prepared by thermal and shear stress processing of a preferred embodiment of the present disclosure and cured with high humidity at 60° C. for 4 hours. FIGS. 11A and 11B exhibit agglomerations as shown in FIGS. 10A and 10B with more rod-like microstructure in each agglomeration indicating increased porosity from a process with a reduced mixing time. The samples exhibit comparable density yet higher porosity than positive active material made by conventional processing.

### EXAMPLE 3

Samples were prepared using additives of a preferred embodiment of the present invention. Specifically, micronized TTBLS of a preferred embodiment of the present disclosure was used. Other additives of a preferred embodiment of the present disclosure, such as micro cellulose fiber, were not used. The samples were prepared in a high-speed, high-shear stress, planetary mixer with aggressive mixing to facilitate the formation of TTBLS, but a high mixing temperature was not maintained.

Sodium sulfate Na₂SO₄ (0.61 weight percent), leady oxide (59.2 weight percent PbO and about 17.3 weight percent Pb₃O₄), SureCure (4.5 weight percent), and a Teflon suspension having 60% solids and 1.22 specific gravity (0.55 weight percent), were mixed for 1 minute. Deionized water (13.7 weight percent) was pre-heated to about 82° C. and added to the mixer and mixing continued for another 2 minutes. Sulfuric acid having 1.4 g/cc specific gravity (3.7 weight percent) was added to the mixer at a controlled rate and mixing continued for another 2 minutes. An additional 0.5 weight percent of water was then added to the mixture and mixing continued for an additional two minutes and the mixture was allowed to cool.

FIG. 12A is an SEM micrograph image of positive active material that was prepared by the addition of SureCure without the addition of SolkaFloc at an initial temperature above 80° C. and dry-cured at 43° C. for 45 minutes. FIG. 12B is an SEM micrograph image of positive active material that was prepared by the addition of SureCure without the addition of SolkaFloc at an additional temperature above 80° C. and wet-cured at 50° C. for 4 hours. The density was comparable to that of a conventional positive active material paste. FIGS. 12A and 12B exhibit increased uniform formation of needle-like crystals and increased porosity. The samples exhibit enhanced formation of TTBLS.

### EXAMPLE 4

Samples were prepared using additives of a preferred embodiment of the present invention. Specifically, micronized TTBLS (SureCure) of a preferred embodiment of the present disclosure and micro cellulose fiber (SolkaFloc) were both used. The samples were prepared in a high-speed, high-shear stress, planetary mixer with lower temperature processing.

Sodium sulfate Na₂SO₄ (0.63 weight percent), leady oxide (60.4 weight percent PbO and 14 weight percent Pb₃O₄), SureCure (0.58 weight percent), Solka-Floc (2.5 weight percent), a Teflon suspension having 60% solids and 1.22 specific gravity (0.56 weight percent), and deionized water (14.6 weight percent) were added to the mixer and mixed for 2 minutes. Sulfuric acid having 1.4 g/cc specific gravity (3.7 weight percent) was added to the mixer at a controlled rate and mixing continued for another 2 minutes. An additional 0.7 weight percent water was added to the mixture and mixing continued for an additional two minutes. Then an additional 2.3 weight percent water was added to the mixture and mixing continued for 2 more minutes. The mixture was then cured in ambient humidity and at a temperature of 43° C. for 45 minutes and analyzed.

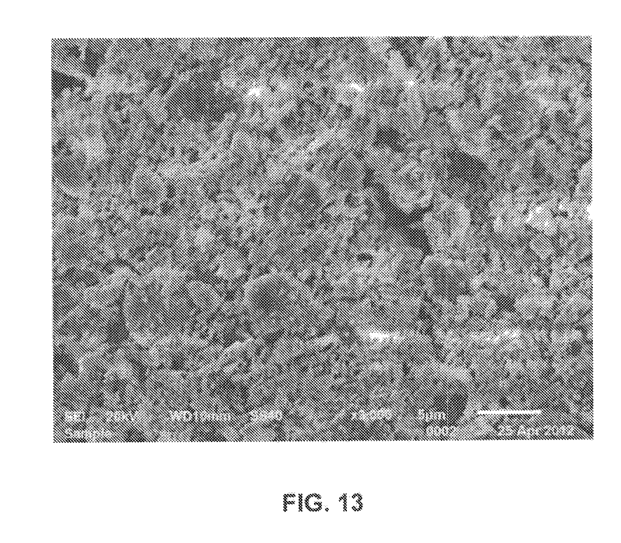

FIG. 13 is an SEM micrograph image of positive active material that was prepared by the addition of SureCure and SolkaFloc at a temperature below 80° C. and dry-cured at 43° C. for 45 minutes. The sample exhibits the formation of TTBLS even at relatively low mixing temperatures. FIG. 13 exhibits increased uniform formation of needle-like crystals providing increased porosity.

### EXAMPLE 5

Samples were prepared using additives of a preferred embodiment of the present invention. Specifically, micronized TTBLS (SureCure) of a preferred embodiment of the present disclosure and micro cellulose fiber (SolkaFloc) were both used. The samples were prepared in a high-speed, high-shear stress, planetary mixer while maintaining a high paste temperature.

Sodium sulfate Na₂SO₄ (0.61 weight percent), leady oxide (58.8 weight percent PbO and about 17.2 weight percent Pb₃O₄), SureCure (0.76 weight percent), Solka-Floc (1.9 weight percent), and a Teflon suspension having 60% solids and 1.22 g/cc specific gravity (0.55 weight percent) were mixed for 1 minute. Deionized water (15.8 weight percent) was pre-heated to about 85° C. and added to the mixer and mixing continued for another 2 minutes. Sulfuric acid having 1.4 g/cc specific gravity (2.8 weight percent) was added to the mixer at a controlled rate and mixing continued for another 5 minutes. An additional 0.7 weight percent of water was then added to the mixture and mixing continued for one minute. Additional sulfuric acid having 1.4 specific gravity (0.9 weight percent) was added to the mixer at a controlled rate and mixing continued for another 2 minutes and the mixture was allowed to cool. The mixture was intermediately re-heated to above 75° C. after each mixing step and before adding more sulfuric acid, if the temperature dropped below 75° C.

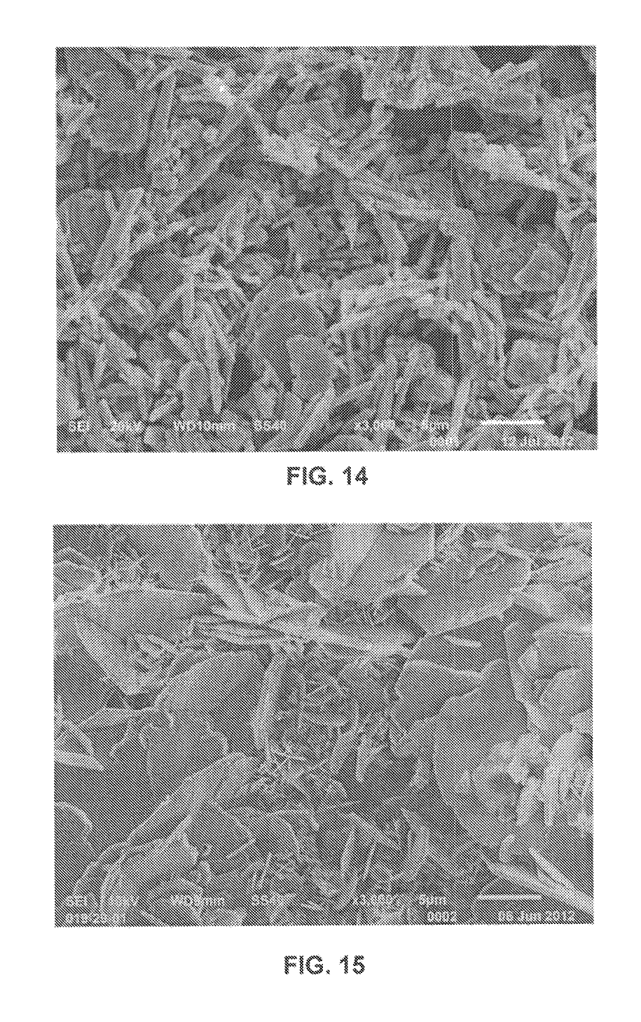

FIG. 14 is an SEM micrograph image of positive active material that was prepared by the addition of SureCure and SolkaFloc at a temperature above 80° C. in a planetary mixer and cured with high humidity at 60° C. for 4 hours.

### EXAMPLE 6

Additional samples were prepared using additives of a preferred embodiment of the present invention. Specifically, higher percentages of micronized TTBLS (SureCure) were used than in Examples 4 and 5, above. The samples were prepared in a high-speed, high-shear stress, planetary mixer at lower final paste temperatures.

Sodium sulfate Na₂SO₄ (0.59 weight percent), leady oxide (56.5 weight percent PbO and about 16.5 weight percent Pb₃O₄), SureCure (4.35 weight percent), Solka-Floc (1.8 weight percent), and a Teflon suspension having 60% solids and 1.22 g/cc specific gravity (0.55 weight percent) were mixed for 1 minute. Deionized water (15.2 weight percent) was pre-heated to about 80° C., pre-acidified to a pH of 1.5 with sulfuric acid having 1.4 g/cc specific gravity, and added to the mixer and mixed for another 2 minutes. Sulfuric acid having 1.4 g/cc specific gravity (2.8 weight percent) was added to the mixer at a controlled rate and mixing continued for another 2 minutes. An additional 0.87 weight percent of water at 60° C. was then added to the mixture and mixing continued for two more minutes and the mixture was allowed to cool.

FIG. 15 is an SEM micrograph image of positive active material that was prepared by the addition of higher concentrations of SureCure and SolkaFloc at a temperature above 80° C. and cured with high humidity at 50° C. for 4 hours. FIG. 15 exhibits increased formation of uniform, needle-like crystals providing increased porosity. In particular, FIG. 15 exhibits the formation of twinned-plate like structures which the present inventors believe may contribute to higher porosity.

### EXAMPLE 7

A conventional negative material paste was prepared from lead oxide powder using convention processing.

Sodium sulfate Na₂SO₄ (about 0.6 to 0.7 weight percent) and 80 weight percent lead oxide-PbO, and about 3 weight percent of the expander (Hammond HE-C-6 MaxLife®) were are added to the mixer and mixed for 2 minutes. De-ionized water (about 12 weight percent) is heated to about 65° C. and added to the mixer promptly over a period of less than 60 secs. Mixing continued for another 2 to 3 minutes. Teflon suspension having 60% solids and 1.22 g/cc specific gravity (about 0.4 weight percent) was then added and mixing continued for 6 to 7 minutes. Sulfuric acid having 1.4 g/cc specific gravity (about 4 weight percent) was then added to the mixer at a controlled rate, over a period of 4 minutes and mixing continued between additions. The temperature of the mix was recorded every minute during this time to record the peak temperature. A peak temperature not exceeding 50° C. was maintained after the last addition of sulfuric acid. Mixing continued until the mix cooled to below about 37° C. The mixture was then analyzed for density and penetrometer values.

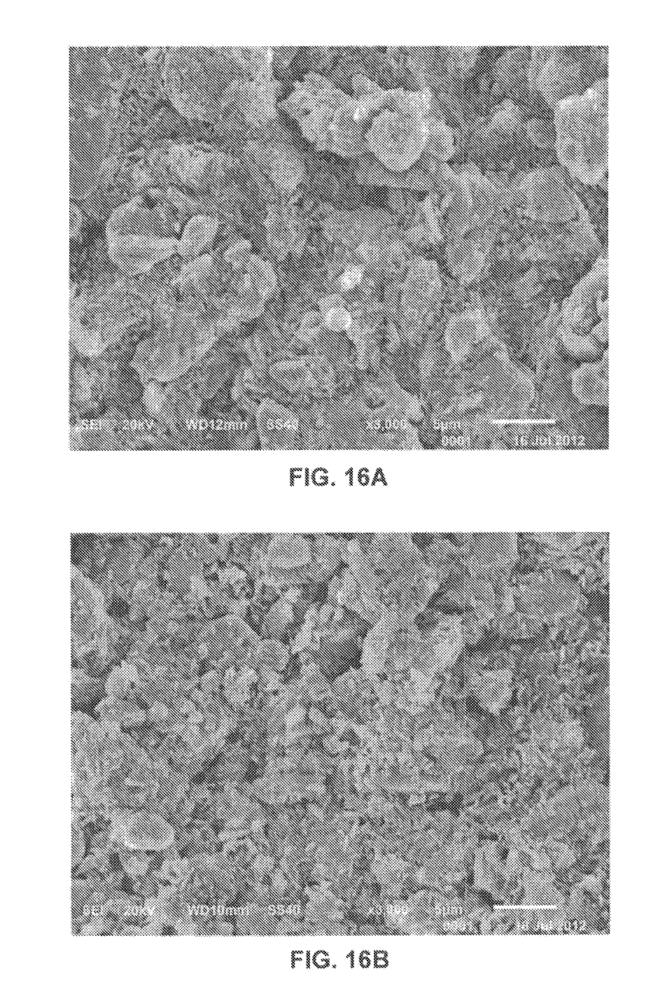

FIGS. 16A and 16B are micrographs of negative active material made by conventional processing. The microstructure features substantially spherical agglomerations of lead sulfates.

### EXAMPLE 8

A negative active material of the present invention was prepared from lead oxide powder using a high speed, high shear stress, planetary mixer.

Sodium sulfate Na₂SO₄ (0.66 weight percent), leady oxide (75.7 weight percent PbO), Hammond HE-6-Maxlife (3.3 weight percent), and a Teflon suspension having 60% solids and 1.22 g/ccspecific gravity (0.57 weight percent) were mixed for 1 minute. Deionized water (16.6 weight percent) was added to the mixer and mixing continued for another 2 minutes. The mixture was then heated to 43° C. to improve the efficiency of the Teflon binder and mixing continued for an additional 2 minutes. Sulfuric acid having 1.4 g/cc specific gravity (3.2 weight percent) was added to the mixer at a controlled rate and mixing continues for another 4 minutes and the mixture was allowed to cool.

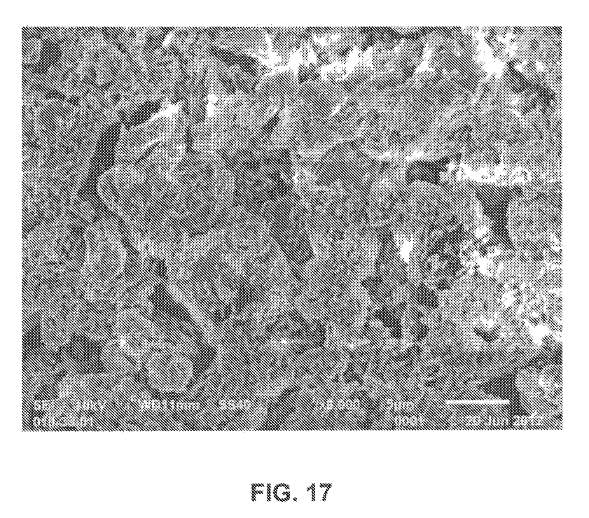

FIG. 17 is a micrograph of a negative active material of a preferred embodiment of the present disclosure. The morphology of the paste is similar to the morphology of the conventional paste yet can be prepared in a much shorter mixing time.

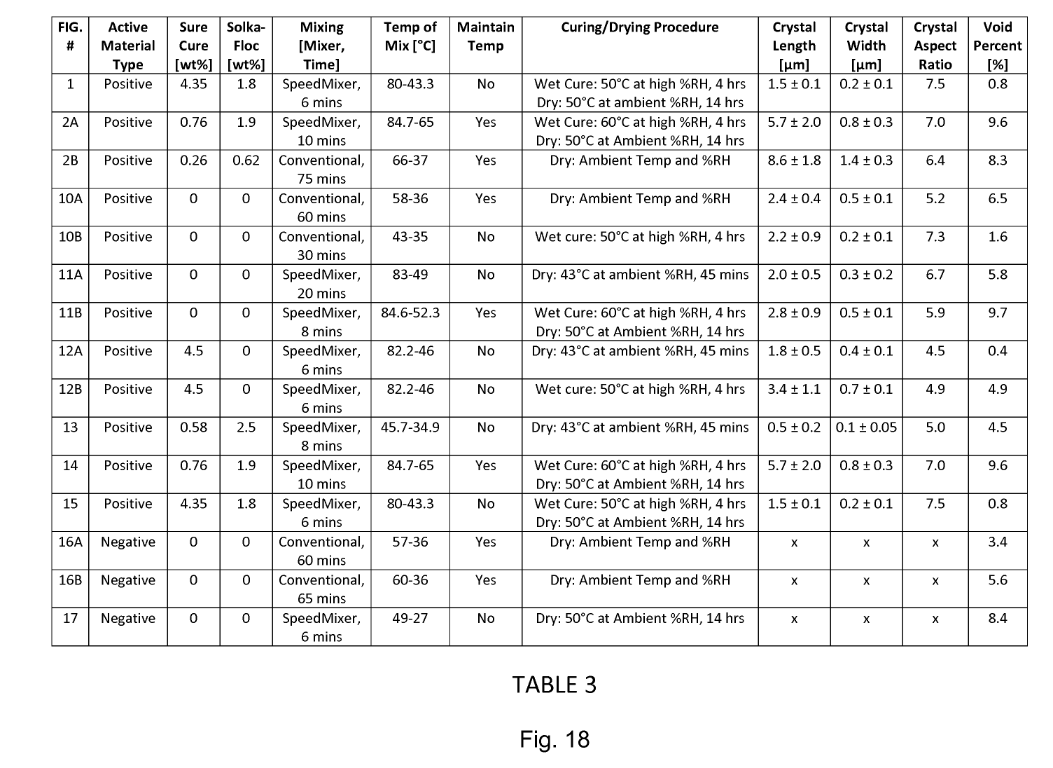

Conclusions: FIG. 18, Table 3, depicts a comparison of conventional positive and active materials relative to various embodiments of the present disclosure. With respect to the positive active material, the present inventors have observed that the formation of TTBLS can be enhanced by either thermal and high-shear stress processing and/or the addition of certain additives such as micronized TTBLS and micro cellulosic or polymeric fibers. The positive active materials of the present invention exhibit increased mechanical stability and enhanced cycle life.

Similarly, negative active materials of the present disclosure exhibit similar microstructures as the conventionally-prepared negative electrode paste, and maintain the performance features of negative active pastes, including mechanical stability even though they have been prepared in a high speed mixer. This reduces substantially electrode processing times.

Embodiments of the present disclosure may enable the use of lead-acid batteries in micro and mild-hybrid applications of vehicles, either alone or in combination with Ni-MH or Li-ion batteries. Embodiments of the present disclosure, however, are not limited to transportation and automotive applications. Embodiments of the present disclosure may be of use in any area known to those skilled in the art where use of electrochemical cells, and in particular lead-acid batteries, is desired, such as stationary power uses and energy storage systems for back-up power situations, as well as other battery applications.

Embodiments of the present disclosure are not limited to transportation and automotive applications. Embodiments of the present disclosure may be of use in any area known to those skilled in the art where use of lead-acid batteries is desired, such as stationary power uses and energy storage systems for back-up power situations. Further, the present inventors intend that the elements or components of the various embodiments disclosed herein may be used together with other elements or components of other embodiments.

Other embodiments of the disclosure will be apparent to those skilled in the art from consideration of the specification and practice of the invention disclosed herein. For example, various elements or components of the disclosed embodiments may be combined with other elements or components of other embodiments, as appropriate for the desired application. Thus, it is intended that the specification and examples be considered as exemplary only, with a true scope and spirit of the disclosure being indicated by the following claims.

It will be apparent to persons of ordinary skill in the art that various modifications may be made in various elements of the present disclosure. Thus it is intended that these variations be considered part of the present disclosure provided they come within the scope of the present disclosure and the appended claims.

1. A metal oxide powder adapted for use in making an active material for electrochemical cells, comprising,
first particles having a first size distribution having a first peak value,
second particles having a second size distribution having a second peak value,
said peak value of said second size distribution being less than or equal to about one-half the peak value of said peak value of said first size distribution,
and said second particles comprising from about 10 to about 50 weight percent of the total weight of said first and second particles.

2. The powder of claim 1, wherein the electrochemical cell is a lead-acid electrochemical cell.

3. The powder of claim 1, said first size distribution comprising said peak value about equal to or less than 15 microns across.

4-5. (canceled)

6. The powder of claim 1, said second size distribution comprising said peak value about equal to or less than about 1 micron across.

7. The powder of claim 1, said first distribution comprising said peak value about equal to or less than 10 microns across and said second size distribution comprising said peak value about equal to or less than 1 micron across.

8-9. (canceled)

10. The powder of claim 1, said second particles comprising not more than about 20 weight percent of said first particles.

11. The metal oxide powder of claim 1, further comprising lead monoxide.

12. The metal oxide powder of claim 1, further comprising, red lead.

13. The metal oxide powder of claim 1, further comprising said first particles having been formed by thermal/plasma spraying.

14. The metal oxide powder of claim 1, further comprising said second particles having been formed by thermal/plasma spraying.

15. The metal oxide powder of claim 1, further comprising said second particles having been impact ball-milled.

16. The metal oxide powder of claim 1, further comprising said second particles having been ground.

17. A process for making a positive active material paste for use in making an electrochemical cell, comprising the steps of:
suspending a metal oxide powder in water;
shearing said suspension to form a homogeneous paste;
curing the paste to form an active material;
forming at least 10 weight percent tetra-basic lead sulfate in the cured paste.

18-21. (canceled)

22. The process of claim 17, further comprising mixing said suspended metal oxide powder with a nucleating agent.

23. (canceled)

24. The process of claim 17, further comprising mixing said suspended metal oxide powder with a shrink-mitigating agent.

25. The process of claim 17, further comprising heating said suspension to foster the formation of tetra-basic lead sulfate.

26. The process of claim 17, further comprising shearing said suspension to foster the formation of tetra-basic lead sulfate.

27. The process of claim 17, further comprising forming the paste having less than or equal to about 4% shrinkage upon curing.

28. The process of claim 17, further comprising forming the paste having a density of between about 3.9 g/cm³ and about 4.4 g/cm³.

29. The process of claim 17, further comprising forming the paste having a standard globe penetrometer reading of greater than or equal to about 35.

30. A mixture of metal oxide powder and additives adapted of use in making an active material paste for an electrochemical cell, comprising,
metal oxide particles having a size distribution about equal to or less than about 15 microns across;
a nucleating agent for fostering the formation of tetra-basic lead sulfate;
water; and
sulfuric acid;
the paste having a density of between about 3.9 g/cm³ and about 4.4 g/cm³, and
the paste having a standard globe penetrometer reading of greater than or equal to about 35.

31. The paste of claim 30 further comprising a shrink-mitigating agent.

32. The paste of claim 30 comprising at least 10 weight percent tetra-basic lead sulfate.

33-35. (canceled)

36. The paste of claim 30 comprising a crystal structure characterized by particles having an aspect ratio of from on or about 5:1 to one or about 10:1.

37-43. (canceled)

44. An electrochemical cell comprising,
positive active material having a microstucture characterized by greater than or equal to 10 weight percent tetra-basic lead sulfate in the cured paste;
said positive active material further comprising microstructures having an aspect ratio greater than or equal to 5:1;
the cell having less than or equal to 20% loss in capacity over the cycle life of the cell; and
and cycle life of the cell greater than or equal to about 1,500 cycles at less than or equal to 80% depth of discharge.

45. The electrochemical cell of claim 44, further comprising the active material having specific capacity greater than or equal to about 68 mAh/g.

46. The electrochemical cell of claim 44, further comprising specific capacity greater than or equal to about 70 mAh/g.

47. The electrochemical cell of claim 44, further comprising specific capacity greater than or equal to about 80 mAh/g.

48. The electrochemical cell of claim 44 further comprising the cell being fully charged for one formation cycle at 270% of charge and exhibiting flat impedance.

49. The electrochemical cell of claim 44 being fully charged at a voltage of 2.28 volts per cell and exhibiting stable C/3 cycling.
